(19) United States
(12) Patent Application Publication
(10) Pub. No.: US 2018/0184621 A1
(43) Pub. Date: Jul. 5, 2018

(54) ERGONOMIC PET HARNESS WITH ENHANCED RETRACTABLE LEASH

(71) Applicant: Mark Wayne Trevino, PASADENA, TX (US)

(72) Inventor: Mark Wayne Trevino, PASADENA, TX (US)

(21) Appl. No.: 15/398,603

(22) Filed: Jan. 4, 2017

(51) Int. Cl. A01K 27/00

(52) U.S. Cl. CPC A01K 27/004; A01K 27/008; A01K 27/006; A01K 27/002

(57) ABSTRACT

An ergonomic pet harness with an enhanced retractable leash is provided. The harness includes a harness assembly coupled to the pet, a leash mechanism with a housing coupled to the harness assembly and having an upper slot and a side opening, a rotatable spool disposed within the housing and having an upper face with a plurality of compartments disposed thereon, and a string member wound around the spool and extending out the housing's side opening, and a brake member detachably coupled to the housing's upper slot. The brake member has a protrusion designed to extend into one of the plurality of compartments in the spool to restrict rotation of the spool based on movement of the protrusion within the one of the plurality of compartments, thereby maintaining a desired length of the string member extended out the housing's side opening.

### BACKGROUND

The embodiments herein relate generally to harnesses for use with pets.

Individuals often use harnesses and/or leashes to control their pets when engaging in activities such as walking, running, and the like. This is particularly useful when training or entertaining pets. There exist a variety of harnesses and/or leashes in the field such as the devices disclosed in U.S. Patent Application Publications 2013/0276717 and 2009/0159014, and U.S. Pat. No. 7,461,615. However, these devices have several disadvantages.

In particular, these existing harnesses and leashes are limited because they comprise: 1) leash ends that are not ergonomic and therefore difficult to grasp and maneuver; and/or 2) leash locking mechanisms to retain a leash in a desired position, which rely on sharp components such as teeth that are prone to wear, failure and frequent maintenance or replacement. In addition, these existing harnesses are limited because they do not provide the user the option of using a variety of accessories thereon such as reflective members to enhance visibility, light assemblies to enhance safety, and the like.

As such, there is a need in the industry for an ergonomic pet harness that addresses the limitations of the prior art, which comprises a retractable leash mechanism with improved durability and ease of use. There is a further need for the harness to have a variety of accessories such as light assemblies and reflective members conveniently attached thereto.

### SUMMARY

An ergonomic harness for use with a pet with an enhanced retractable leash is provided. The harness comprises a harness assembly coupled to the pet and comprising a front portion, a top portion and side portions connecting the front and top portions, a leash mechanism comprising a housing coupled to the harness assembly and comprising an upper slot and a side opening, a rotatable spool disposed within the housing and comprising an upper face and a lower face, the upper face of the spool comprising a plurality of compartments disposed thereon and arranged along a circular pathway, and a string member wound around the spool and extending out the side opening in the housing, and a brake member detachably coupled to the upper slot of the housing, the brake member comprising a protrusion configured to extend into one of the plurality of compartments in the spool to restrict rotation of the spool based on movement of the protrusion within the one of the plurality of compartments, thereby maintaining a desired length of the string member extended out the side opening in the housing.

### BRIEF DESCRIPTION OF THE FIGURES

The detailed description of some embodiments of the invention will be made below with reference to the accompanying figures, wherein the figures disclose one or more embodiments of the present invention.

FIG. 1 depicts a perspective view of certain embodiments of the pet harness shown in use;

FIG. 2 depicts a side view of certain embodiments of the pet harness shown in use;

FIG. 3 depicts a front view of certain embodiments of the pet harness;

FIG. 4 depicts a bottom view of certain embodiments of the pet harness shown in use;

FIG. 5 depicts a bottom perspective view of certain embodiments of the pet harness;

FIG. 6 depicts an exploded view of certain embodiments of the pet harness;

FIG. 7 depicts a perspective view of certain embodiments of the pet harness illustrating the retractable leash mechanism;

FIG. 8 depicts a section view of certain embodiments of the pet harness taken along line 8-8 in FIG. 7;

FIG. 9 depicts an exploded view of certain embodiments of the pet harness illustrating the retractable leash mechanism;

FIG. 10 depicts a bottom perspective view of certain embodiments of the pet harness illustrating the retractable leash mechanism;

FIG. 11 depicts a section view of certain embodiments of the pet harness illustrating the retractable leash mechanism in an unlocked configuration; and

FIG. 12 depicts a perspective view of certain embodiments of the pet harness illustrating the retractable leash mechanism in a locked configuration.

### DETAILED DESCRIPTION OF CERTAIN EMBODIMENTS

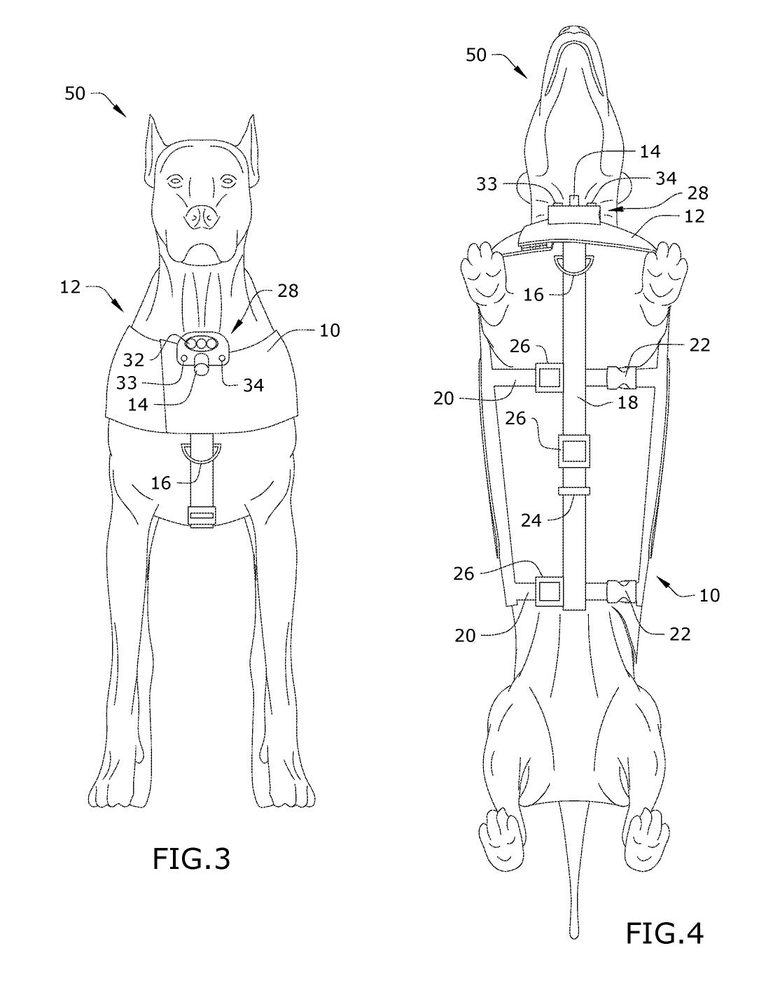

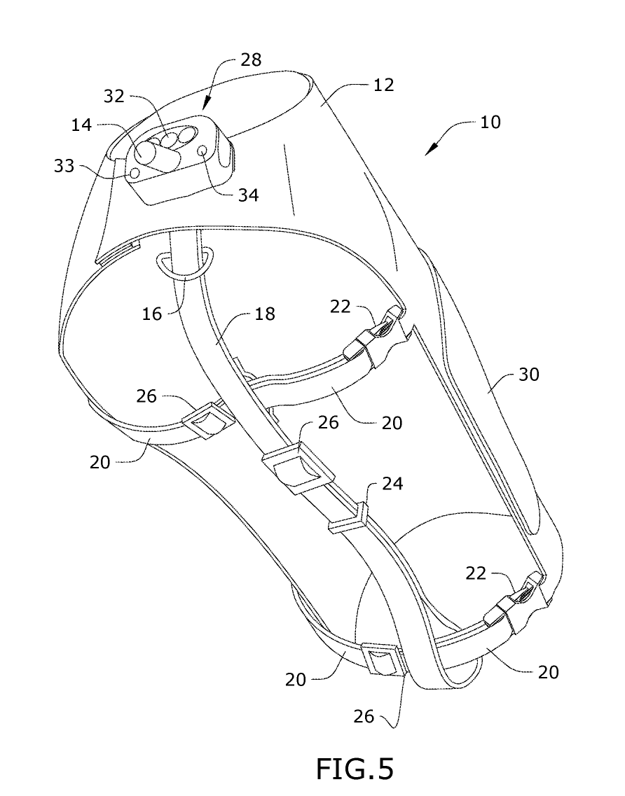

As depicted in FIGS. 1-5, pet harness 10 is configured to be secured to a pet such as dog 50 and generally comprises fabric body 12, center strap 18, cross straps 20, retractable leash mechanism 42 and light assembly 28. However, it shall be appreciated that pet harness 10 may be used with alternative animals known in the field.

Fabric body 12 generally comprises a front portion with a pair of flaps wrapped around a neck of dog 50. In one embodiment, the pair of flaps of fabric body 12 are secured together by hook and loop fasteners. However, alternative fasteners such as snap components, slide fasteners, or the like, may be used instead. The top portion of fabric body 12 is disposed on the back of dog 50. Side portions of fabric body 12 wrap around the sides of dog 50 and are secured in place by center strap 18 and cross straps 20. Center strap 18 is adjustable via adjustment component 26 and strap ring 24. In one embodiment, vest ring 16 is disposed around center strap 18 and is configured to secure an item such as an identification tag thereto. Each cross strap 20 is adjustable via adjustment component 26 and extends across the bottom region of dog 50. Each cross strap 20 is secured in place by buckle 22.

In certain embodiments of the invention, reflective pocket 30 is coupled to a side portion of fabric body 12. Reflective pocket 30 is made from a material that enhances the visibility of dog 50 to other individuals. Reflective pocket 30 comprises a pouch that is configured to store one or more accessories (not shown). The pouch of reflective pocket 30 may be sealable by components such as hook and loop fasteners, snap components, and the like. It shall be appreciated that pet harness 10 may have a pair of reflective pockets 30, one coupled to each side portion of fabric body 12.

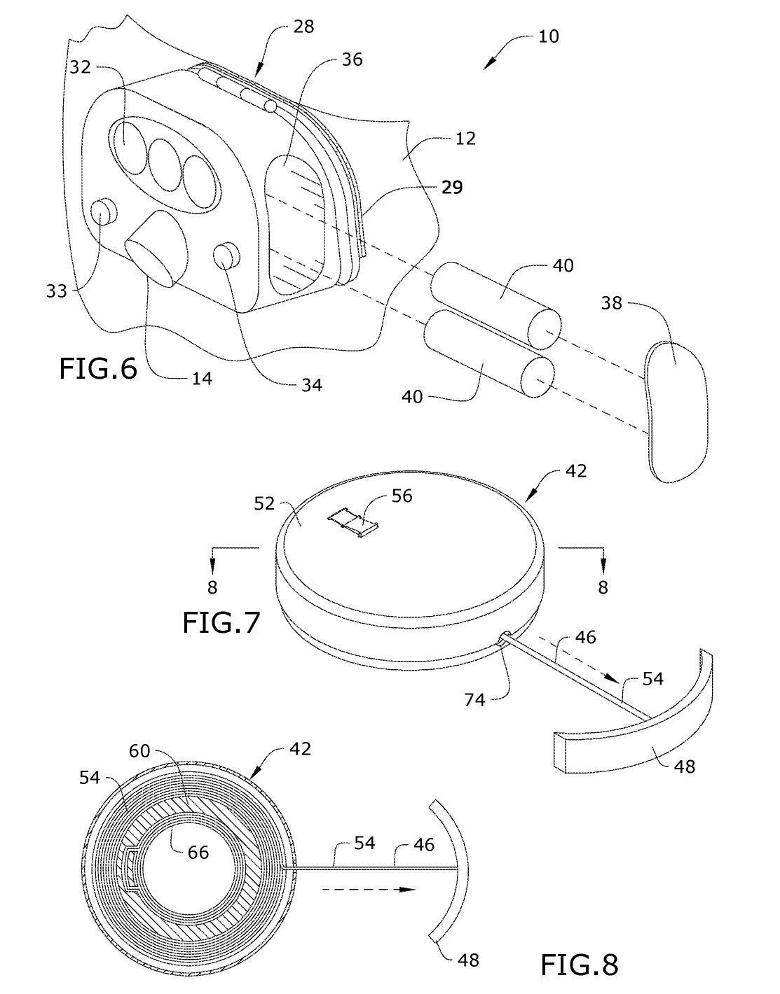

As depicted in FIG. 6, light assembly 28 is coupled to the front portion of fabric body 12 by fastener 28, which may be an adhesive or hook/loop fasteners. In certain embodiments, light assembly 28 comprises light-emitting diodes (“LED”) 32, laser 14, LED on/off switch 33, and laser switch 34. In one embodiment, light-emitting diodes 32 are aligned together. Light assembly 28 further comprises compartment 36 configured to store batteries 40. Compartment door 38 is secured to compartment 36 to enclose batteries 40. Light assembly 28 comprises an internal circuit board (not shown) that electrically couples light-emitting diodes 32, LED on/off switch 33, laser 14, laser switch 34 and batteries 40 together. Light-emitting diodes 32 are configured to illuminate the area in front of dog 50. Laser 14 may serve as an exercise toy to enable dog 50 to run after the emitted laser beam.

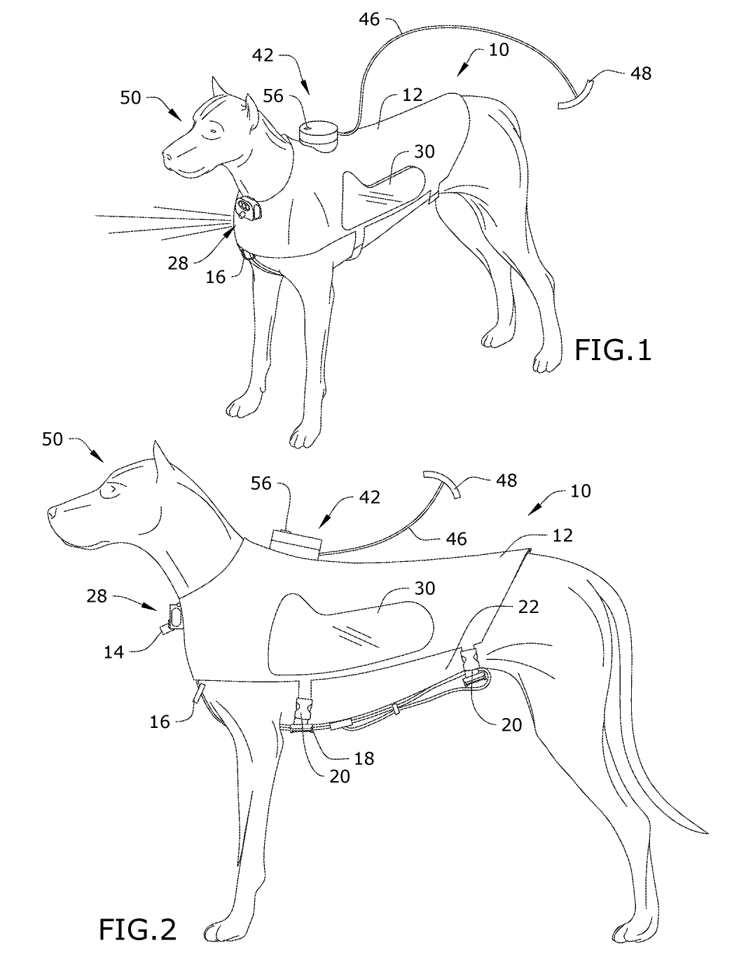

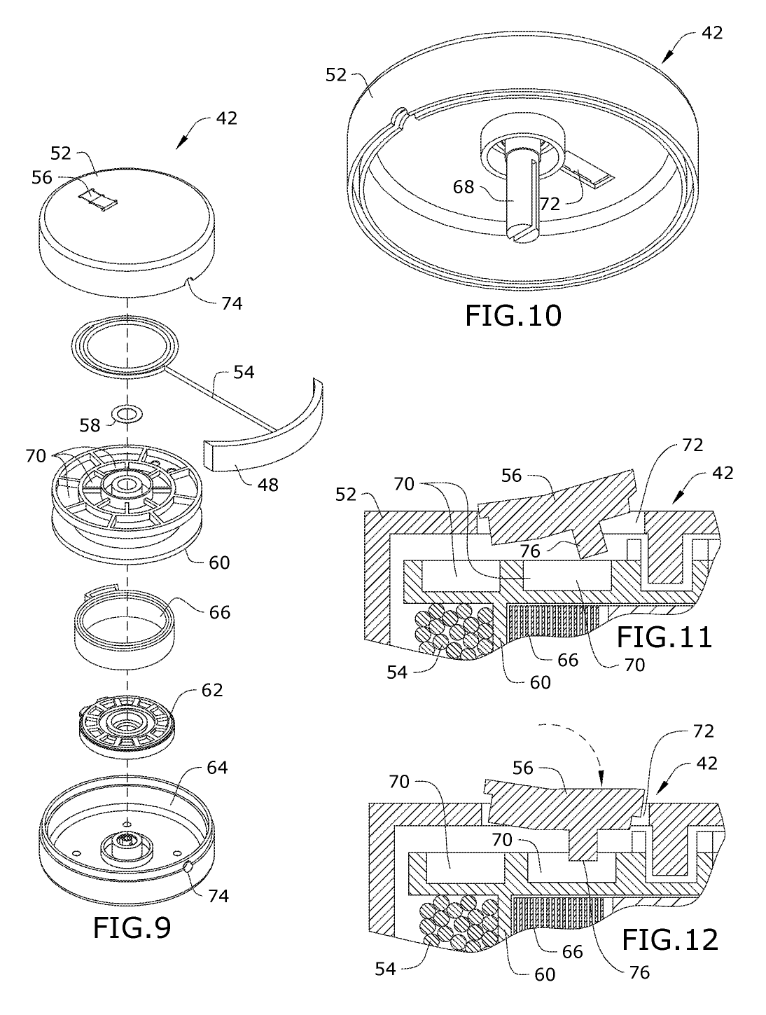

As depicted in FIGS. 1-2, retractable leash mechanism 42 is coupled to the top portion of fabric body 12 and generally comprises leash 46 and curved handle 48. As depicted in FIGS. 7-10, retractable leash mechanism 42 comprises upper cover 52, lower cover 64, string 54 coupled to curved handle 48, washer 58, spool 60, spring 66 and spool cap 62.

Spool cap 62 is disposed on lower cover 64. Spring 66 comprises a coiled spring member that is coupled to spool cap 62. Spool 60 comprises an upper face with a plurality of compartments 70 and a lower face coupled to spring 66. In a preferred embodiment, the plurality of compartments 70 are arranged along a circular pathway on spool 60. Washer 58 is disposed on the upper face of spool 60. Leash 46 comprises string 54 wound around spool 60 and comprising an end with curved handle 48. String 54 is preferably a nylon string that extends out of side openings 74 in upper and lower covers 52, 64. Upper cover 52 comprises upper slot 72 and rod 68. Upper cover 52 is coupled to lower cover 64 to enclose spool cap 62, spring 66, spool 60, washer 58 and a portion of nylon string 54. In this configuration, rod 68 of upper cover 52 extends through washer 58, spool 60, spring 66, and spool cap 62 to secure the components together.

In operation, a user (not shown) pulls curved handle 48 to extend string 54 to a desired length. In this motion, spring 66 permits spool 60 to rotate in a first direction to enable string 54 to extend out of side openings 74 in upper and lower covers 52, 64. The user releases curved handle 48 to permit string 54 to retract. During this action, spring 66 permits spool 60 to rotate in a second direction to retract string 54 in side openings 74 in upper and lower covers 52, 64. The curvature in curved handle 48 provides a surface that is easy to grab and enhances user comfort.

As depicted in FIGS. 11-12, brake member 56 is used with retractable leash mechanism 42 to maintain a desired length of string 54 outside upper and lower covers 52, 64. Brake member 56 is detachably coupled to upper slot 72 of upper cover 52 and comprises protrusion 76. As depicted in FIG. 11, the removal of brake member 56 removes protrusion 76 from any compartments 70 in spool 60. This permits spool 60 to freely rotate in the first and second directions to extend and retract string 54. As depicted in FIG. 12, the insertion of brake member 56 in upper slot 72 of upper cover 52 permits protrusion 76 to extend into one of the plurality of compartments 70. This restricts the rotation of spool 60 based on the movement of protrusion 76 within compartment 70, thereby maintaining a desired length of string 54 extended outside upper and lower covers 52, 64.

In operation, pet harness 10 is secured to dog 50 as described above. String 54 of retractable leash mechanism 42 is adjusted to the desired length and locked into place. A user (not shown) grabs curved handle 48 to control and/or maneuver dog 50 as needed. Light assembly 28 may be activated as needed to illuminate the immediate area and/or entertain dog 50. Accessories may be stored within reflective pockets 30 as needed.

It shall be appreciated that the components of pet harness 10 described in several embodiments herein may comprise any alternative known materials in the field and be of any color, size and/or dimensions. It shall be appreciated that the components of pet harness 10 described herein may be manufactured and assembled using any known techniques in the field.

Persons of ordinary skill in the art may appreciate that numerous design configurations may be possible to enjoy the functional benefits of the inventive systems. Thus, given the wide variety of configurations and arrangements of embodiments of the present invention the scope of the invention is reflected by the breadth of the claims below rather than narrowed by the embodiments described above.

What is claimed is:

1. An ergonomic harness for use with a pet with an enhanced retractable leash, the harness comprising:
a harness assembly coupled to the pet and comprising a front portion, a top portion and side portions connecting the front and top portions;
a leash mechanism comprising a housing coupled to the harness assembly and comprising an upper slot and a side opening, a rotatable spool disposed within the housing and comprising an upper face and a lower face, the upper face of the spool comprising a plurality of compartments disposed thereon and arranged along a circular pathway, and a string member wound around the spool and extending out the side opening in the housing; and
a brake member detachably coupled to the upper slot of the housing, the brake member comprising a protrusion configured to extend into one of the plurality of compartments in the spool to restrict rotation of the spool based on movement of the protrusion within the one of the plurality of compartments, thereby maintaining a desired length of the string member extended out the side opening in the housing.

2. The ergonomic harness of claim 1, wherein the housing of the leash mechanism comprises an upper cover and a lower cover detachably coupled together.

3. The ergonomic harness of claim 2, wherein the leash mechanism further comprises a spool cap disposed on the lower cover of the housing member, and a spring coupled to the spool cap and the lower face of the spool, wherein the spring permits the spool to rotate in a first direction to enable the string member to extend out the side opening in the housing with the desired length, wherein the spring permits the spool to rotate in a second direction to enable the string member to retract in the side opening in the housing.

4. The ergonomic harness of claim 3, further comprising a washer disposed on the upper face of the spool.

5. The ergonomic harness of claim 4, wherein the upper cover of the housing comprises a rod coupled to the lower cover of the housing and extending through the washer, spool, spring and spool cap.

6. The ergonomic harness of claim 5, further comprising a curved handle coupled to an end of the string member.

7. The ergonomic harness of claim 6, wherein the harness assembly comprises a plurality of adjustable straps configured to secure the harness assembly to the pet.

8. The ergonomic harness of claim 7, further comprising a light assembly coupled to the front portion of the harness assembly, the light assembly comprising at least one laser and at least one light-emitting diode.

9. The ergonomic harness of claim 8, wherein the at least one light-emitting diode comprises a plurality of light-emitting diodes aligned together

10. The ergonomic harness of claim 9, further comprising a reflective pocket coupled to one of the side portions of the harness assembly.
